(19) United States
(12) Patent Application Publication
(10) Pub. No.: US 2022/0198007 A1
(43) Pub. Date: Jun. 23, 2022

(54) SYSTEMS AND METHODS FOR PERFORMING URL CLOSURE CHECK IN DISTRIBUTED SYSTEMS

(71) Applicant: Citrix Systems, Inc., Fort Lauderdale, FL (US)

(72) Inventor: Rama Rao Katta, Freemont, CA (US)

(73) Assignee: Citrix Systems, Inc., Fort Lauderdale, FL (US)

(21) Appl. No.: 17/126,867

(22) Filed: Dec. 18, 2020

(51) Int. Cl. G06F 21/56; G06F 9/54; G06F 16/901

(52) U.S. Cl. CPC G06F 21/56; G06F 16/901; G06F 9/544

(57) ABSTRACT

Described embodiments provide systems and methods for validating a request to access a resource. A device can receive a first request from the client that includes a first resource of the server. The device may add the first resource to an accessed-resource list of a session between the client and the server. The device may receive a response from the server to the first request that includes a second resource. The device may incorporate a mapping between an indication of the second resource and the first resource, to a shared data structure. The device within the session may receive a second request that includes a third resource of the server. The device may determine to allow the server to receive the second request when an indication of the third resource is mapped to at least one resource in the shared data structure that is present in the accessed-resource list.

### FIELD OF THE DISCLOSURE

The present application generally relates to protecting resources from unauthorized access, including but not limited to systems and methods for performing resource request verification in distributed systems.

### BACKGROUND

Certain protocols can execute one or more processes that are vulnerable to unauthorized/malicious attempts to access one or more resources. Some approaches may provide protective mechanisms against said attempts. For example, one or more approaches may configure one or more points of entry/access to a resource. An authorized user may use the one or more points of entry to access a resource and/or navigate/traverse to other resources. At least one problem with said approaches may be a failure to provide adequate protection against unauthorized attempts by an attacker to randomly access/traverse the one or more resources. Failing to provide adequate protection can provide the attacker with increased accessibility to sensitive/secured information.

### SUMMARY

This Summary is provided to introduce a selection of concepts in a simplified form that are further described below in the Detailed Description. This Summary is not intended to identify key features or essential features, nor is it intended to limit the scope of the claims included herewith.

The present disclosure is directed towards systems and methods for validating a request to access a resource (e.g., a uniform resource locator (URL) and/or other resources) and/or a service (e.g., an application resource, such as a web application, SaaS application or remote-hosted network application). A device (e.g., a gateway module, a local/foreign node, and/or an application delivery controller (ADC)) intermediary between a client and a server (e.g., a backend server supporting hypertext transfer protocol (HTTP) and/or hypertext transfer protocol secure (HTTPS)) may receive/obtain/process a first request from the client (e.g., a smartphone, a laptop, a tablet device, a desktop computer of a user, and/or a client supporting HTTP/HTTPS). The device may correspond to a cluster of devices comprising one or more devices (e.g., distributed systems). The first request/message (e.g., HTTP GET, GET/index.html, and/or other requests) may include/provide/specify/indicate a first resource of the server (e.g., a resource, service, and/or application hosted on the server). Responsive to receiving/obtaining the first request, the device may add/append/incorporate the first resource (e.g., HTTP REQUEST URL and/or other resources) to an accessed-resource list (e.g., ACCESSED_URL_LIST). In some embodiments, the device may process/parse/analyze/evaluate a received response from the server (e.g., HTTP RESPONSE) to the first request, wherein the response can include/indicate/specify one or more resources.

For each resource of the one or more resources, the device can incorporate a mapping/association/relationship (e.g., a parent to child relationship and/or other mappings) between an indication of the resource (e.g., a unique identifier (ID) of the resource and/or the resource itself) and the first resource to a shared data structure (e.g., a shared/global database, a shared/global parent list, and/or other structures). For example, the device may create/generate/produce a unique ID for each resource in the response from the server. The device may incorporate/integrate/generate a mapping between each unique ID and the first resource to a global parent list. The device may use the global parent list to specify/indicate that the first resource is a parent resource of each resource from the server response. Each resource from the server response in the global parent list may be identified/specified/indicated by a unique ID.

In some embodiments, the device may receive a subsequent request (e.g., a second request) that includes a third resource of the server. Responsive to receiving the subsequent request, the device may fetch/obtain a corresponding shared data structure for the third resource (e.g., a corresponding PARENT_LIST for a URL in a HTTP REQUEST). The device may determine whether the accessed-resource list (e.g., ACCESSED_URL_LIST) includes/provides/specifies at least one resource of the corresponding shared data structure. If the accessed-resource list includes at least one resource of the corresponding shared data structure, the device may allow the server to receive/obtain the subsequent request. Otherwise, the device may determine to prevent/preclude the server from receiving the subsequent request.

In one aspect, the present disclosure is directed to a method for validating a request to access a resource. The method can include receiving, by a device intermediary between a client and a server, a first request from the client that includes a first resource of the server. The device may add the first resource to an accessed-resource list of a session between the client and the server. The device may receive a response from the server to the first request, that includes a second resource. The device may incorporate a mapping between an indication of the second resource and the first resource, to a shared data structure. The device within the session may receive a second request that includes a third resource of the server. The device may determine to allow the server to receive the second request when an indication of the third resource is mapped to at least one resource in the shared data structure that is present in the accessed-resource list.

In some embodiments, the device may determine to prevent the server from receiving the second request when the at least one resource is absent in at least one of: the shared data structure or the accessed-resource list. The device may determine that the second request is malicious or potentially malicious when the at least one resource is absent in at least one of: the shared data structure or the accessed-resource list. In some embodiments, the device may establish a session identifier for the session. The device may communicate the response to the client, the response including a set-cookie command with the session identifier. The device may receive the second request. The second request may include a cookie with the session identifier. The device may access the accessed-resource list of the session according to the session identifier. The device may determine the session identifier from the second request. The device may validate the session identifier determined from the second request.

In certain embodiments, the shared data structure includes one-to-many mappings between resources associated with a plurality of sessions. The device may parse the first resource from the first request. The device may communicate the first request to the server after parsing the first resource from the first request. In some embodiments, the device may add the third resource to the accessed-resource list of the session between the client and the server. The device may receive a response from the server to the second request, that includes a fourth resource. The device may incorporate a mapping between an indication of the fourth resource and the third resource, to the shared data structure.

In one aspect, the present disclosure is directed to a device for validating a request to access a resource. The device may comprise at least one processor. The at least one processor may be configured to receive a first request from a client that includes a first resource of the server. The at least one processor may be configured to add the first resource to an accessed-resource list of a session between the client and the server. The at least one processor may be configured to receive a response from the server to the first request, that includes a second resource. The at least one processor may be configured to incorporate a mapping between an indication of the second resource and the first resource, to a shared data structure. The at least one processor may be configured to receive a second request that includes a third resource of the server within the session. The at least one processor may be configured to determine to allow the server to receive the second request when an indication of the third resource is mapped to at least one resource in the shared data structure that is present in the accessed-resource list.

In some embodiments, the at least one processor may be configured to determine to prevent the server from receiving the second request when the at least one resource is absent in at least one of: the shared data structure or the accessed-resource list. The at least one processor may be configured to determine that the second request is malicious or potentially malicious when the at least one resource is absent in at least one of: the shared data structure or the accessed-resource list. The at least one processor may be configured to establish a session identifier for the session. The at least one processor may be configured to communicate the response including a set-cookie command with the session identifier to the client. The at least one processor may be configured to receive the second request, the second request including a cookie with the session identifier. The at least one processor may be configured to access the accessed-resource list of the session according to the session identifier. In some embodiments, the at least one processor may be configured to determine the session identifier from the second request. The at least one processor may be configured to validate the session identifier determined from the second request.

In certain embodiments, the data structure may include one-to-many mappings between resources associated with a plurality of sessions. The at least one processor may be configured to parse the first resource from the first request. The at least one processor may be configured to communicate the first request to the server after parsing the first resource from the first request. In some embodiments, the at least one processor may be configured to add the third resource to the accessed-resource list of the session between the client and the server. The at least one processor may be configured to receive a response from the server to the second request, that includes a fourth resource. The at least one processor may incorporate a mapping between an indication of the fourth resource and the third resource, to the shared data structure.

In one aspect, the present disclosure is directed to a non-transitory computer readable medium storing program instructions for validating a request to access a resource. The program instructions stored in a non-transitory computer readable medium may cause at least one processor to receive a first request from a client that includes a first resource of the server. The at least one processor may reside in a device. The program instructions can cause the at least one processor to add the first resource to an accessed-resource list of a session between the client and the server. The program instructions may cause the at least one processor to receive a response from the server to the first request, that includes a second resource. The program instructions may cause the at least one processor to incorporate a mapping between an indication of the second resource and the first resource, to a shared data structure. The program instructions may cause the at least one processor to receive a second request that includes a third resource of the server within the session. The program instructions may cause the at least one processor to determine to allow the server to receive the second request when an indication of the third resource is mapped to at least one resource in the shared data structure that is present in the accessed-resource list.

In some embodiments, the program instructions may cause the at least one processor to establish a session identifier for the session. The program instructions can cause the at least one processor to communicate the response including a set-cookie command with the session identifier to the client.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a system for validating a request to access a resource, in accordance with an illustrative embodiment;

FIG. 4 is a communication diagram of a system for validating a request to access a resource, in accordance with an illustrative embodiment; and

FIG. 5 is a flow diagram of an example method for validating a request to access a resource, in accordance with an illustrative embodiment.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for validating a request to access a resource.

### A. Network and Computing Environment

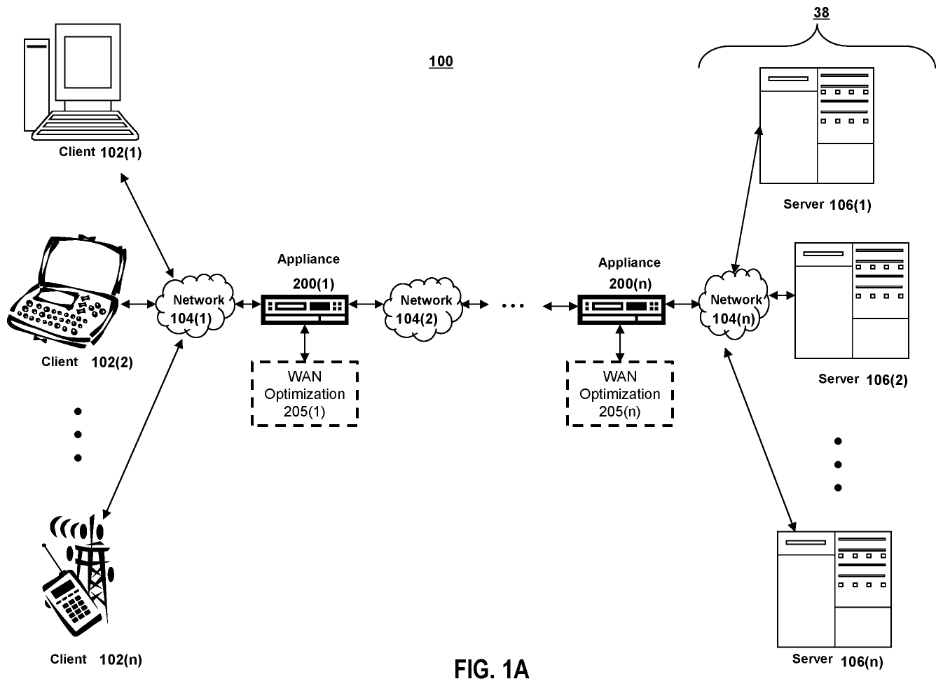

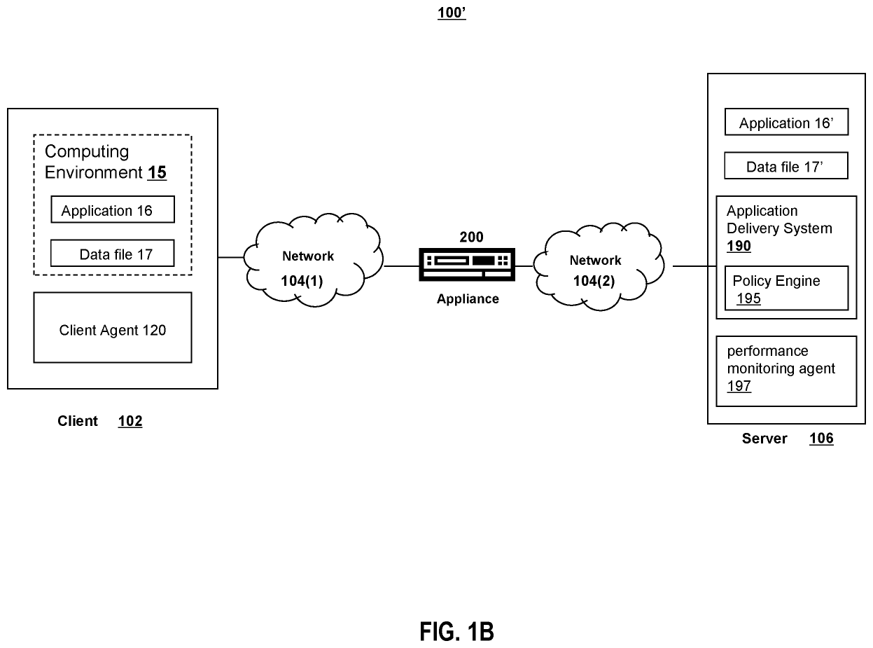

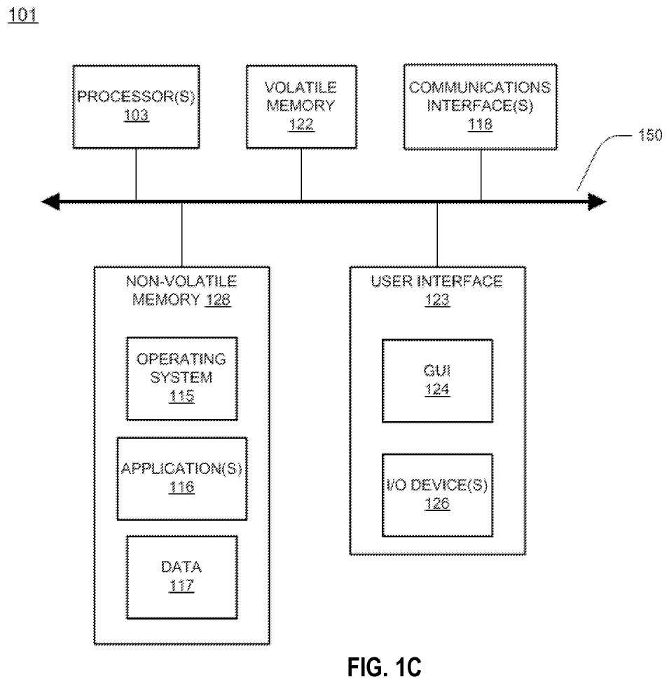

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, Fla.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, Fla.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, Fla. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, Fla.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

Additional details of the implementation and operation of network environment 100, clients 102, servers 106, and appliances 200 and 205 may be as described in U.S. Pat. No. 9,538,345, issued Jan. 3, 2017 to Citrix Systems, Inc. of Fort Lauderdale, Fla., the teachings of which are hereby incorporated herein by reference.

### B. Appliance Architecture

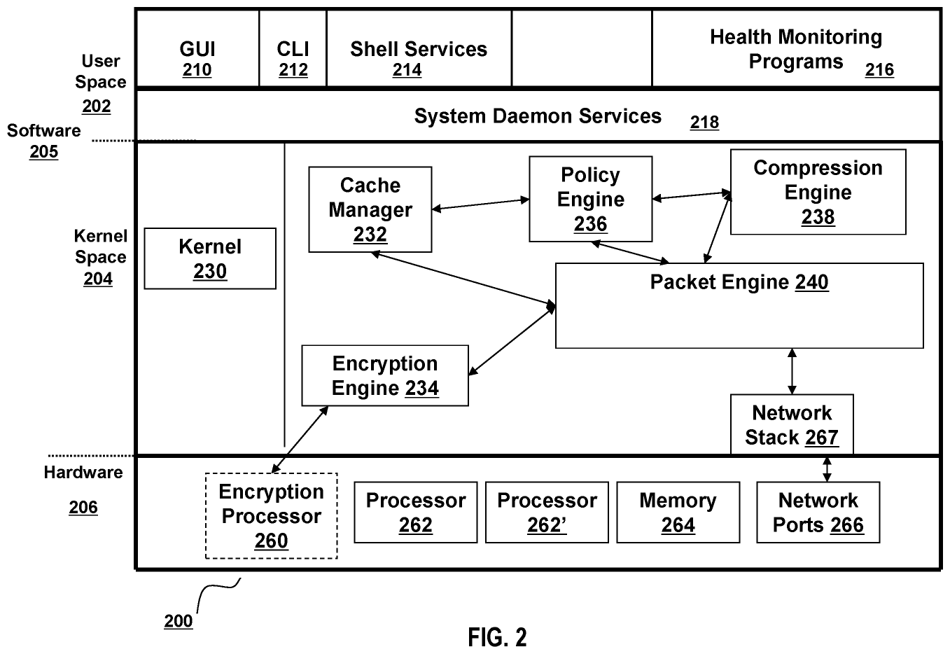

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, Fla. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

Additional details of the implementation and operation of appliance 200 may be as described in U.S. Pat. No. 9,538,345, issued Jan. 3, 2017 to Citrix Systems, Inc. of Fort Lauderdale, Fla., the teachings of which are hereby incorporated herein by reference.

### C. Systems and Methods for Validating a Request to Access a Resource

Certain protocols (e.g., hypertext transfer protocol (HTTP), hypertext transfer protocol secure (HTTPS), secure sockets layer (SSL), transport layer security (TLS), and/or other protocols) may execute one or more methods (e.g., HTTP GET and/or other methods) that are vulnerable to unauthorized/malicious attempts to access one or more resources (e.g., one or more uniform resource locators (URLs) of a web server/service). Certain approaches (e.g., start uniform resource locator (URL) check and/or other approaches) may provide protective mechanisms against said attempts. For example, in certain approaches, one or more points of entry/access to a resource may be configured via a list (e.g., a start URL list). An authorized user may use the list to access a resource and/or navigate/traverse to other resources (e.g., closure URLs). At least one problem with said approaches may be a failure to provide adequate protection against unauthorized attempts by an attacker to randomly access/traverse the one or more resources.

The systems and methods presented herein include a novel approach for preventing unauthorized attempts to access/retrieve/use/traverse/navigate one or more resources (e.g., URLs). The novel approach includes one or more mechanisms to validate/confirm/verify whether a resource of a request/message (e.g., a HTTP REQUEST URL) is a valid resource (e.g., a closure URL). Therefore, the novel approach may prevent random/unauthorized/malicious access/traversal/usage/retrieval of a resource (e.g., a web server/service). The systems and methods presented herein may reduce/decrease memory usage by at least 25% (e.g., 35, 45 or other percent) for example. Current methods for validating requests may utilize a large amount of memory to store/maintain information/records of one or more resources of a response to a request on a per-session basis. In comparison, the systems and methods presented herein may store/maintain/record information/records of the resources accessed by the client during a session, which may be considerably less than the one or more resources of the response to the request.

The present disclosure is directed towards systems and methods for validating/verifying/authenticating/confirming a request to access/traverse/use a resource. A device (e.g., a gateway module, a local/foreign node, network appliance and/or an application delivery controller (ADC)) intermediary between a client and a server (e.g., a backend server supporting hypertext transfer protocol (HTTP) and/or hypertext transfer protocol secure (HTTPS)) may receive/obtain/process a first request from the client (e.g., a smartphone, a laptop, a tablet device, a desktop computer of a user, and/or a client supporting HTTP/HTTPS). Responsive to receiving/obtaining the first request/message (e.g., HTTP GET, GET/index.html, and/or other requests), the device may create/generate/configure/establish a session between the client and the server (e.g., CLIENT SESSION). In some embodiments, the device may establish a session identifier for the session. The session identifier (ID) may include or correspond to a session token and/or other information that uniquely identifies a session and/or the details of the session (e.g., messages/requests/resources exchanged during a session). The session between the client and the server may be valid/active for a configured/predetermined timeout interval/instance. The session and/or session identifier may be used to track/monitor the resources accessed/used/visited by the client.

In some embodiments, the first request may include/provide/specify/indicate a first resource of the server (e.g., a resource, service, and/or application hosted on the server). Responsive to receiving/obtaining the first request, the device may add/append/incorporate the first resource (e.g., HTTP REQUEST URL and/or other resources) to an accessed-resource list (e.g., ACCESSED_URL_LIST). Adding the first resource to the accessed-resource list may indicate/specify that the client accessed/used/visited the first resource during the session. In some embodiments, the device may process/parse/analyze/evaluate a received response from the server (e.g., HTTP RESPONSE) to the first request, wherein the response can include/indicate/specify one or more resources. For each resource of the one or more resources, the device can incorporate a mapping/association/relationship (e.g., a parent to child relationship and/or other mappings) between an indication of the resource (e.g., a unique identifier (ID) of the resource and/or the resource itself) and the first resource to a shared data structure (e.g., a shared/global database, a shared/global parent list, and/or other structures). For example, the device may create/generate/produce a unique ID for each resource in the response from the server. The device may incorporate/integrate/generate a mapping between each unique ID and the first resource to a global parent list (or other shared data structures). The device may use the global parent list to specify/indicate that the first resource is a parent resource of each resource from the server response. Each resource from the server response in the global parent list may be identified/specified/indicated by a unique ID.

In certain embodiments, the shared data structure may not be limited to a particular request (e.g., HTTP REQUEST), response (e.g., a server response) and/or session (e.g., session between the client and the server). For example, the information/data included in the shared data structure may be global (e.g., accessible outside a particular request/response/session). The key to access the shared data structure may include or correspond to a resource of a request (e.g., a HTTP request URL). In some embodiments, the shared data structure may include/specify/indicate one-to-many (e.g., 1 to N) mappings between resources associated with a plurality of sessions. For example, a resource (e.g., a URL and/or other resources) may be related/associated/mapped/linked to one or more parent resources (e.g., parent URLs and/or parent resources). Responsive to receiving the response from the server, the device may send/transmit/forward/communicate the response to the client. The response may include/provide/specify/indicate a set-cookie command and/or the session identifier (e.g., CLIENT SESSION ID). One or more requests received by the device may include/provide a cookie (e.g., a HTTP cookie configured by the set-cookie command) and/or session identifier.

In some embodiments, the device may receive a subsequent request (e.g., a second request) that includes a third resource of the server. The subsequent request may include/provide/specify the cookie and/or session identifier. The device may extract/obtain/acquire/use the cookie and/or session identifier from the subsequent request. In some embodiments, the device may validate/verify/confirm the cookie and/or session identifier of the subsequent request. Responsive to receiving the subsequent request, the device may fetch/obtain/acquire the details of the session based on the extracted session identifier. Furthermore, the device may obtain the accessed-resource list (e.g., using the session identifier) and/or a corresponding shared data structure for the third resource (e.g., a corresponding PARENT_LIST for a URL in a second HTTP REQUEST). The device may determine whether the accessed-resource list (e.g., ACCESSED_URL_LIST) includes/provides/specifies at least one resource of the corresponding shared data structure. If the accessed-resource list includes at least one resource of the corresponding shared data structure, the device may allow the server to receive/obtain the subsequent request. Otherwise, the device may determine to prevent/preclude the server from receiving the subsequent request.

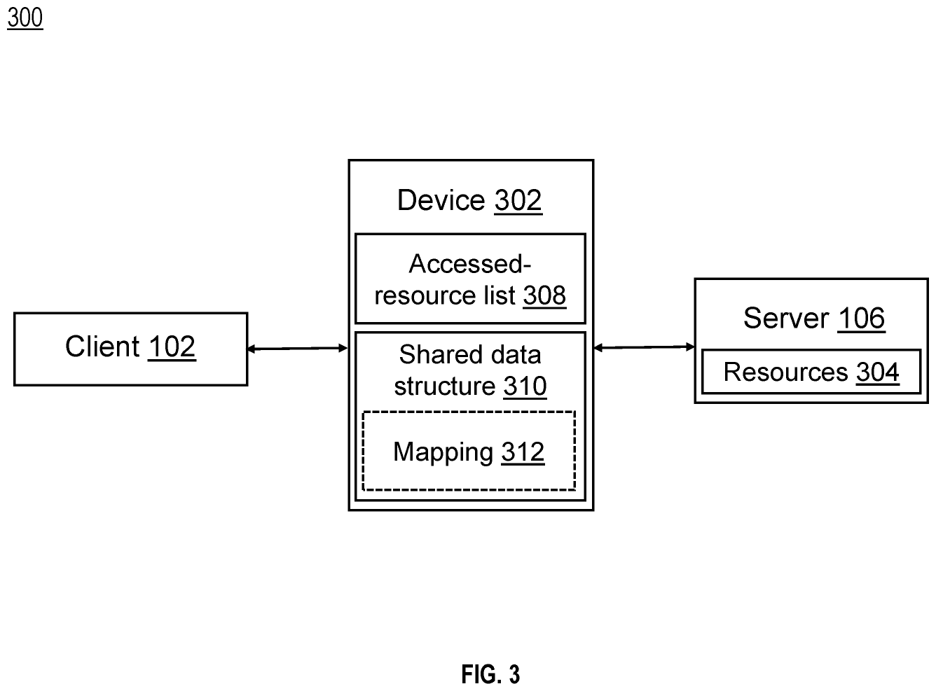

Referring to FIG. 3, depicted is a block diagram of one example embodiment of a system 300 for validating a request to access/traverse a resource, e.g., to prevent random/unauthorized access of a resource. The system 300 may include one or more clients 102 of an entity, one or more devices 302, and/or one or more servers 106 hosting one or more resources 304. The device 302 can include or maintain or have access to an accessed-resource list 308, a shared data structure 310 and/or a mapping 312.

Each of the above-mentioned elements or entities is implemented in hardware, or a combination of hardware and software, in one or more embodiments. Each component of the system 300 may be implemented using hardware or a combination of hardware or software detailed above in connection with FIG. 1C. For instance, each of these elements or entities can include any application, program, library, script, task, service, process or any type and form of executable instructions executing on hardware of a client device 102, a server 106 and/or a network device 200 in connection with FIGS. 1B-1C, for instance. The hardware includes circuitry such as one or more processors in one or more embodiments.

The system 300 may include one or more servers 106. The server 106 (e.g., a backend server supporting HTTPS messages or transactions, and/or other servers 106) may be configured and/or designed to host one or more resources 304 (e.g., one or more URLs) and/or services (e.g., application resources, as a web application, SaaS application or remote-hosted network application). The server 106 may be configured and/or designed to provision the one or more resources 304 and/or services to one or more clients 102 of a consumer or other entity (e.g., an organization or user), via one or more networks 104. For example, the client 102 may establish one or more sessions or connections (e.g., secured or otherwise, such as a SSL virtual private network connection) with the server(s) 106 to access a service/resource 304 (e.g., via one or more URLs), such as an application resource. In another example, the server(s) 106 may receive/obtain a request (e.g., a first/second request, such as a HTTP request) from the client 102 (e.g., via a device 302) to access/use one or more resources 304 (or establish the connections to access the one or more resources 304). The server(s) 106 may receive/obtain a first resource 304(1) (or other resources) via the request. For example, a first request may include/specify/indicate/provide the first resource 304(1) (or other information) to the server(s) 106.

Responsive to receiving the request(s), the server(s) 106 may send/transmit/broadcast a response to the client 102 via the device 302. The server(s) 106 may provide/indicate/specify one or more resources 304 (or other information) via the response. For example, the response from the server(s) 106 may indicate/include one or more resources 304. The one or more resources 304 may be associated/mapped to the first resource 304(1) (or other resources) of the request received by the server 106. In some embodiments, the server(s) 106 can be part of a cloud or datacenter for instance. The server(s) 106 may include any embodiment of volatile memory 122 or non-volatile memory 128 (discussed in FIG. 1C for example) which may store files, data and/or content of the service. The server(s) 106 may communicate with other various components of the system 300 in FIG. 3 via a communications interface 118 for instance. Hence, the server(s) 106 may be similar in some aspects to the computer 101 described with reference to FIG. 1C.

To provide a service/resource 304, the server(s) 106 may execute, provide, provision, and/or host one or more network application(s). In some embodiments, a service/resource 304 may be referred to interchangeably with an application, application resource or network application. A network application can for instance include a remote-hosted application, a remote-hosted desktop, a web application or a software-as-a-service (SaaS) application. A remote-hosted desktop may be a virtual desktop hosted on the server 106 which is accessed by or remotely provisioned to the client 102. In some embodiments, the delivery of a remote-hosted desktop may be via a session and/or connection based on High-Definition User Experience (HDX) or Independent Computing Architecture (ICA) display remoting protocol, or Remote Desktop Protocol (RDP). A remote-hosted application may include/correspond to an application service that can be delivered via a HDX-based, ICA-based, RDP-based, etc., session and/or connection. In some embodiments, a remote-hosted application may be an application which is installed on/in the remote-hosted desktop environment and is therefore accessible within the remote-hosted desktop. A SaaS application can be a centrally-hosted application which is typically accessible on a subscription basis. In some embodiments, the SaaS applications may include web-based applications. In other embodiments, the SaaS applications may correspond to remote-hosted applications and, therefore, can be delivered in HDX/ICA/RDP-based sessions and/or connections. SaaS applications and/or web applications may include for instance salesforce.com, SAP, Microsoft Office 365, Dropbox or Gmail service, Amazon web services, and so on.

The system 300 may include one or more clients 102. The client 102 may include or correspond to devices of a consumer of the service. For example, if the consumer is an individual or user, the client 102 may comprise a smartphone, a laptop (e.g., at home), a tablet device, and a desktop computer (e.g., at work), that the user may use to access an application resource (e.g., Dropbox service) and/or other resources 304 at various times and/or locations for instance. In an example where the consumer is an organization, such as an enterprise, the consumer can extend over a number of users (e.g., management persons, staff members, IT administrators, and so on) and their associated client(s) 102 or devices (e.g., corporate-issued device, personally-owned devices, and/or registered/approved devices (e.g., in a BYOD program)). Any number of the users may access a service/resource 304 (e.g., salesforce.com, SAP, Microsoft Office 365) from a service/resource 304 provider, via a corporate account for the service/resource 304 for instance.

The client 102 may be configured and/or designed to access one or more application resource(s) 304 over one or more networks. In some embodiments, the client 102 may interact with the server(s) 106 via a device 302 (e.g., a device 302 intermediary between the client 102 and the server(s) 106). For example, the client 102 may send a request (e.g., a first request, a second request, and/or other requests to access/use a resource 304) and/or message (e.g. a HTTP message and/or other messages) to the server(s) 106 via the device 302. Responsive to sending the request/message, the client 102 may receive/obtain a response from the server 106 and/or a device 302 (e.g., an ADC and/or other devices). In some embodiments, the client 102 may receive one or more resources 304 (e.g., a second resource 304(2) and/or other resources) from the server 106 via the response. For example, responsive to receiving a request, the server 106 may send a response to the client 102 via the device 302. The response may include one or more resources 304 and/or other information. As discussed herein, references to a resource may sometimes refer to an identification/indication/indicator of the resource (e.g., as a uniform resource indicator), and may sometimes refer to the resource itself. The client 102 may use/access/traverse the one or more resources from the server response. In some embodiments, the client 102 may receive/obtain a session identifier (e.g., a session ID and/or session token), a cookie (e.g., a cookie configured by the device 302 for the session), and/or other information via a response from the server 106. The client 102 may use/provide/indicate the session identifier, the cookie, and/or other information to access/use/retrieve/traverse one or more resources 304 of the server 106. The device 302 may incorporate/add/include the session identifier and/or cookie to the response and may forward the response to the client 102.

In some embodiments, the client 102 may receive a response from the device 302 indicating that a resource 304 (e.g., a third resource 304(3)) is invalid/unknown/absent. For example, the client 102 may send a request (e.g., a second request) to use/access a third resource 304(3) of the server 106 via the device 302. The request from the client 102 may include/specify/indicate the third resource 304(3) (or other resources), the session identifier, the cookie, and/or other information. The device 302 may analyze/evaluate the third resource 304(3) (or other information) and/or determine that the resource 304(3) is invalid/unknown/absent. Responsive to the determination that the third resource 304(3) is invalid/absent, the client 102 may receive a response from the device 302. The response from the device 302 may indicate/specify that the client 102 is unable to access/use the third resource 304(3) because the third resource 304(3) is invalid/absent.

The system 300 may include one or more devices 302 (sometimes referred to as appliance(s) 200, gateway(s) 200, node(s), and/or application delivery controllers). A device 302 may be configured and/or designed to serve as an intermediary between different elements of a computer and/or network environment, such as between client(s) 102, server(s) 106, network(s) 104, and/or other devices 302 (e.g., as discussed above in connection with FIG. 2). In some embodiments, the device 302 may receive/obtain a first request/message (e.g., HTTP GET request and/or other requests) from a client 102 and/or user to access one or more resources 304 from the server 106. The first request may include/provide/specify a first resource 304(1) and/or other information. Responsive to receiving the request/message, the device 302 may create/generate/establish a session between the client 102 and the server 106. The device 302 may generate/configure a session identifier (e.g., CLIENT SESSION) for the session. The session identifier may include or correspond to a session ID, a session token and/or other information that uniquely identifies a session and/or the details of the session (e.g., messages/requests/resources exchanged during a session). The session between the client 102 and the server 106 may be valid for a configured/predetermined timeout interval/instance. The session and/or session identifier may be used to track/monitor the resources 304 accessed/used by the client 102.

Responsive to receiving the first request, the device 302 may extract/obtain/acquire the first resource 304(1) (or other information) from the first request. The device 302 may add/incorporate/append the first resource 304(1) to an accessed-resource list 308. In some embodiments, the device 302 may send/forward/route the first request to the server 106. Responsive to sending/transmitting the first request, the device 302 may receive a response from the server 106. The device 302 may parse/analyze/evaluate the response from the server 106 to obtain/extract/acquire one or more resources 304 from the response, such as a second resource 304(2). The device 302 may create/generate/configure an indication (e.g., a unique ID and/or a resource) for each resource from the response. For example, the device 302 may generate a unique ID (or other indications) of the second resource 304(2). In some embodiments, the device 302 may generate a shared data structure 310 (e.g., a PARENT_LIST and/or other structures/databases). The device 302 may generate/configure a shared data structure 310 for each resource 304 from the server response.

Responsive to parsing the response from the server 106, the device 302 may incorporate a mapping 312 (or other information) to the shared data structure 310. The mapping 312 may include or correspond to a mapping between an indication of each resource from the server response (e.g., a unique ID and/or the resource itself) and the first resource 304(1). For example, the device 302 may incorporate a mapping 312 between a second resource 304(2) and a first resource 304(1) to a shared data structure 310, such as a global parent list. The shared data structure 310 may indicate/specify that the first resource 304(1) is a parent resource of the second resource 304(2) (and/or other resources 304 from the server response). In some embodiments, the device 302 may incorporate/include a set-cookie command, the session identifier, and/or other information to the response from the server 106. Responsive to incorporating the set-cookie command and/or the session identifier to the response, the device 302 may forward/send the response to the client 102.

In some embodiments, the device 302 may receive another request (e.g., a second request) from a client 102 and/or user. The second request may include/indicate/specify at least one resource 304, such as a third resource 304(3), to the device 302. The device 302 may receive/obtain the session identifier, the cookie, and/or other information via the second request (e.g., the second request can include the session identifier and/or the cookie). The device 302 may extract/acquire the session identifier and/or the cookie from the second request. Responsive to extracting the session identifier (or other information), the device 302 may validate/confirm/verify the session identifier (e.g., session ID and/or session token). In some embodiments, the device 302 may retrieve/access/obtain the accessed-resource list 308 and/or the shared data structure 310 responsive to receiving the second request. The device 302 may use the session identifier, the third resource 304(3), and/or other information to obtain/access the accessed-resource list 308 and/or the shared data structure 310. For example, the device 302 may access the shared data structure 310 according to the third resource 304(3) and/or other information (e.g., using the third resource 304(3) as a key). The shared data structure 310 may include or correspond to the shared data structure 310 of the third resource 304(3). In another example, the device 302 may use the session identifier (or other information) as a key to obtain the accessed-resource list 308.

In some embodiments, the device 302 may determine whether to allow the server 106 to receive the second request (or other requests). The device 302 may retrieve/obtain/extract one or more resources 304 from the accessed-resource list 308 and/or one or more mappings 312 from the shared data structure 310. Responsive to retrieving the one or more resources 304, the mapping 312, and/or other information, the device 302 may determine whether at least one indication of a resource 304 of the shared data structure 310 is present in the accessed-resource list 308. If the device 302 determines at least one indication of a resource 304 of the shared data structure 310 is present in the accessed-resource list 308, the device 302 may determine to allow the server 104 to receive the second request. For example, the device 302 may determine/find/confirm that an indication of the third resource 304(3) is mapped to at least one resource 304 in the shared data structure 310. The at least one resource 304 may be present in the accessed-resource list 308. Therefore, the device 302 may determine to allow the server 106 to receive the request. In some embodiments, the at least one resource 304 may be absent/excluded from the shared data structure 310 and/or the accessed-resource list 308. If the device 302 determines/find/confirm the at least one resource 304 is absent from the shared data structure 310 and/or the accessed-resource list 308, the device 302 may prevent/preclude the server 106 from receiving the request (e.g., the device 302 may determine the request is malicious and/or potentially malicious).

The device 302 may be located at various points or in various communication paths, for example between two networks 104, within a computing and/or network environment 100. In other embodiments, the device 302 may be located on a network 104. One or more devices 302 may communicate with one another and/or work in conjunction to, for example, accelerate, protect and/or secure network traffic between clients 102 and servers 106 and/or provide load balancing of servers 106 to process requests from clients 102. In some embodiments, the one or more devices 302 may act as a proxy or access server to provide access to the one or more servers 106, provide security and/or act as a firewall between the client 102 and the server 106, and/or provide a secure VPN connection from the client 102 to the server 106, such as a SSL VPN connection and/or provide encryption and decryption operations.

In some embodiments, the device 302 can include, among other elements, a shared data structure 310 and/or an accessed-resource list 308. The shared data structure 310 included in the device 302 may be configured and/or designed to indicate/provide/specify/include a mapping 312 between resources 304. The shared data structure 310 may indicate/provide/specify a mapping 312 (e.g., an association, link, relationship) between an indication of a resource 304 (e.g., a second resource 304(2)) and another resource 304 (e.g., a first resource 304(1)). The indication of the resource 304 may include or correspond to a unique ID of the resource 304 and/or the resource 304 itself. For example, the shared data structure 310 may include a mapping 312 between a first resource 304(1) and an indication of a second resource 304(2) (e.g., a unique ID of the second resource 304(2)). The mapping 312 between the first resource 304(1) and the indication of the second resource 304(2) may indicate that the first resource 304(1) is a parent resource of the second resource 304(2). In some embodiments, the shared data structure 310 may include one-to-many mappings between resources 304 associated with a plurality of sessions. For example, an indication of the second resource 304(2) may be mapped to one or more resources 304 in the shared data structure 310. In some embodiments, the key to access (e.g., to locate an entry/record of) the shared data structure 310 may correspond to a resource 304 (e.g., a resource identifier) of a request. The shared data structure 310 may include or correspond to a global/shared list that is accessible across a plurality of sessions. For example, a client 102 in a second session may access/use/retrieve a shared data structure 310 that is generated/updated/configured in a first session. In some embodiments, a particular resource 304 may have a corresponding shared data structure 310.

The accessed-resource list 308 included in the device 302 may be configured and/or designed to indicate/provide/specify/include one or more resources 304 accessed/used by the client 102. For example, the device 302 may receive a request from the client 102, wherein the request includes at least one resource 304. Responsive to receiving the request, the device 302 may add/incorporate/append the at least one resource 304 to the accessed-resource list 308. The accessed-resource list 308 may provide/indicate a listing of one or more resources 304 accessed/used by the client 102 during a session between the client 102 and the server 106. In some embodiments, the device 302 may retrieve/obtain/use the accessed-resource list 308 according to information of a session. For example, the device 302 may use the session identifier (e.g., a session ID and/or session token) to access/obtain/use the accessed-resource list 308.

In some embodiments, the shared data structure 310 and/or the accessed-resource list 308 may be stored/maintained in a cache of the device 302, a memory 264 of the device 302, and/or a physical memory having a faster access time than memory 264. The shared data structure 310 and/or the accessed-resource list 308 may be located within, outside, or adjacent to the device 302. In some embodiments, the shared data structure 310 and/or the accessed-resource list 308 may interface/interact with each other to determine whether to allow the server 106 to receive a request. For example, the shared data structure 310 and the accessed-resource list 308 may interface/interact with each other to determine whether an indication of a resource 304 is mapped to at least one resource 304 in the shared data structure 310 that is present in the accessed-resource list 308.

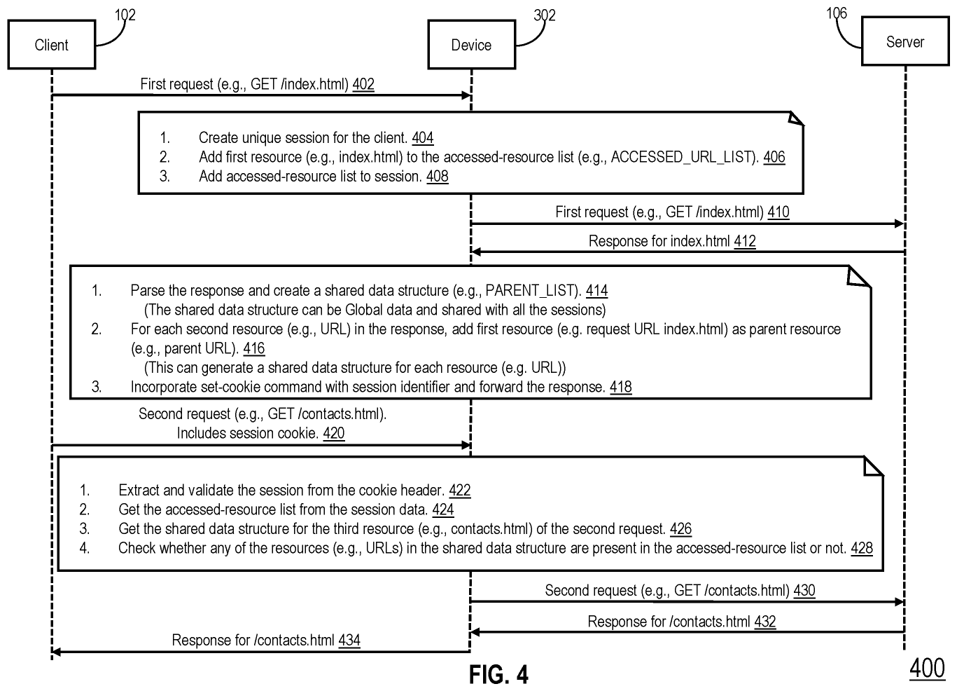

Referring now to FIG. 4, depicted is a communication diagram of an embodiment of a process 400 for validating a request to access a resource. In accordance with process 400, the client 102 may send/transmit/communicate a first request/message (e.g., HTTP GET, GET/index.html, and/or other requests) to the server 106 via the device 302 (402). The first request (e.g., HTTP REQUEST) may comprise a first resource 304(1) (e.g., /index.html and/or other resources) of the server 106. Responsive to receiving/obtaining the request from the client 102, the device 302 may create/generate/configure/establish a unique/new session between the client 102 and the server 106 (404), in some embodiments. The device 302 may generate/establish/provide a session identifier (e.g., session ID, session token, and/or other information) for the unique session. In some embodiments, the device 302 may add/incorporate/append the first resource 304(1) (e.g., the HTTP REQUEST URL, such as/index.html) to an accessed-resource list 308 (e.g., ACCESSED_URL_LIST) (406). The device 302 may indicate/specify/determine that the client 102 accessed the first resource 304(1) during the unique session by adding the first resource 304(1) to the accessed-resource list 308. The device 302 may add/store/maintain the accessed-resource list 308 in the data/information of the session (408).

In some embodiments, the device 302 may forward/send/route/communicate the first request (e.g., GET/index.html) to the server 106 (410). The server 106 may receive/obtain the first request (e.g., a request to access a first resource 304(1)) from the device 302 (410) and/or send/transmit a response (e.g., response for index.html and/or other HTTP responses) to the device 302 (412). The response from the server 106 may include/provide/specify one or more second resources 304(2) (e.g., one or more URLs) and/or other information. Responsive to receiving the response from the server 106, the device 302 may parse/analyze/evaluate the response from the server 106 (414). In some embodiments, the device 302 may create/generate/configure a shared data structure 310 (e.g., PARENT_LIST) (414). The shared data structure 310 may comprise a global list shared/accessible across one or more sessions. In some embodiments, the device 302 may create/generate a shared data structure 310 for each resource 304 (e.g., each resource of a request/response). The shared data structure 310 may represent/specify/indicate/provide the topology of one or more resources 304 (e.g., one or more web pages).

Responsive to parsing/analyzing the response from the server 106, the device 302 may add/incorporate a mapping/association 312 to the shared data structure 310 (416). The mapping 312 may include or correspond to a mapping between an indication of the one or more second resources 304(2) (e.g., a unique ID for each second resource and/or the second resources) and the first resource 304(1). For example, the device 302 may add/incorporate the first resource 304(1) (e.g., index.html and/or other URLs) as a parent resource (e.g., parent URL) to each second resource 304(2) (e.g., from the server response) in the shared data structure 310. Therefore, the shared data structure 310 may specify/indicate that the first resource 304(1) is the parent resource 304 of the one or more second resources 304(2) from the server response. In some embodiments, the shared data structure 310 may include one-to-many mappings between resources 304 associated with a plurality of sessions. For example, each second resource 304(2) (e.g., each URL) and/or indication of each second resource 304(2) can be mapped/associated/related to one or more parent resources 304. In certain embodiments, the device 302 may incorporate/add/integrate a set-cookie command, a session identifier, and/or other information to the response from the server 106 (418). The device 302 may send/forward/transmit/route/communicate the response from the server 106 (e.g., the response including the set-cookie command and/or session identifier) to the client 102 (418). The device 302 may use the set-cookie command to indicate/set/provide a session identifier of the session to the client, to cause the client to include the session identifier in one or more subsequent requests.

In some embodiments, the client 102 may send/transmit/broadcast a second request (e.g., GET/contacts.html and/or other requests) to the server 106 via the device 302 within the session (420). The second request may include/indicate/specify a third resource 304(3) of the server 106 (e.g., /contacts.html and/or other resources), a cookie (e.g., a session cookie), a session identifier, and/or other information. The second request may include or correspond to a request to access/use the third resource 304(3) of the server 106. Responsive to receiving/obtaining the second request, the device 302 may extract/obtain/acquire the session identifier from the second request (422). The device 302 may validate/confirm/verify the session using the session identifier, the cookie and/or other information. In some embodiments, the device 302 may obtain/fetch/access/acquire the accessed-resource list 308 (e.g., ACCESSED_URL_LIST) from the data/information of the session (424). The device 302 may use/apply/provide the session identifier (or other information) as a key to access/obtain/acquire the accessed-resource list 308. Responsive to obtaining the accessed-resource list 308, the device 302 may acquire/fetch/access the shared data structure 310 (e.g., PARENT_LIST) for the third resource 304(3) (e.g., contacts.html and/or other resources) (426). The device 302 may use/provide the third resource 304(3) as a key to access/obtain/use the shared data structure 310.

Responsive to obtaining the accessed-resource list 308 and/or the shared data structure 310, the device 302 may verify/confirm/determine whether at least one resource (e.g., URLs) in the shared data structure 310 is present/specified in the accessed-resource list 308 (428). For example, the device 302 may determine/verify whether an indication of the third resource 304(3) (e.g., a unique ID and/or the resource itself) is mapped to at least one resource in the shared data structure 310. The device 302 may determine whether the at least one resource in the shared data structure 310 is present in the accessed-resource list 308. If the device 302 determines that the at least one resource is present in the accessed-resource list 308, the device 302 may allow the server 106 to receive the second request (e.g., GET/contacts.html) (430). Responsive to receiving the second request, the server 106 may send a response (e.g., a response including one or more resources) to the client 102 (434) via the device 302 (432). If the at least one resource is absent from the shared data structure 310 and/or the accessed-resource list 308, the device 302 may determine to prevent/preclude the server 106 from receiving the second request (e.g., the second request may be malicious and/or potentially malicious). For instance, if the indication of the third resource 304(3) is not mapped to at least one resource in the shared data structure 310, the device 302 may prevent the server 106 from obtaining/receiving the second request.

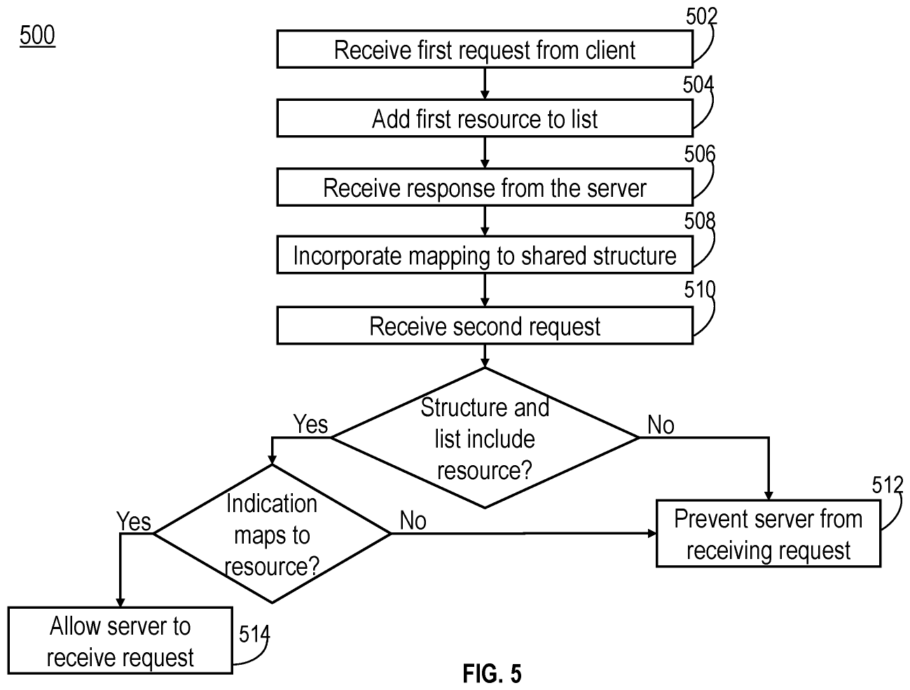

Referring to FIG. 5, depicted is a flow diagram of one embodiment of a method for validating a request to access a resource. The functionalities of the method may be implemented using, or performed by, the components detailed herein in connection with FIGS. 1-4. In brief overview, a device 302 may receive a first request from a client 102 (502). The device 302 may add a first resource 304(1) to an accessed-resource list 308 (504). The device 302 may receive a response from the server 106 (506). The device 302 may incorporate a mapping 312 to a shared data structure 310 (508). The device 302 may receive a second request (510). In some embodiments, the device 302 may determine whether the shared data structure 310 and/or accessed-resource list 308 include an indication of a third resource 304(3). The device 302 may prevent a server 106 from receiving a second request (512). In some embodiments, the device 302 may determine whether the indication of the third resource 304(3) maps to at least one resource 304 in the shared data structure 310. The device 302 may allow the server 106 to receive the second request (514).

Referring now to operation (502), and in some embodiments, a device 302 may receive/obtain a first request from a client 102. The device 302 (e.g., an ADC and/or other devices) may be intermediary between the client 102 and a server 106. For example, an ADC intermediary between the client 102 and the server 106 may receive an HTTP REQUEST to a URL, such as/index.html. Responsive to receiving the first request, the ADC (or other devices 302) may create/generate a session identifier for a session between the client 102 and the server 106. The session and/or session identifier (e.g., session ID and/or session token) can be used to track the resources 304 accessed/visited by the client 102 during the session. The first request (e.g., HTTP GET and/or other requests) may include/indicate/specify a first resource 304(1) (for example, a first URL) of the server 106. The first request may include or correspond to a request to access/use one or more resources 304 of the server 106, such as a first resource 304(1). Responsive to receiving/obtaining the first request, the device 102 may add the first resource 304(1) of the first request to an accessed-resource list 308. In some embodiments, the device 302 may parse/separate/analyze the first resource 304(1) from the first request. Responsive to parsing the first resource 304(1) from the first request, the device 302 may communicate/send/transmit/broadcast the first request to the server 106.

Referring now to operation (504), and in some embodiments, the device 302 may add/incorporate/integrate/append the first resource 304(1) to the accessed-resource list 308. The received first request (e.g., received by the device 302) may include/provide/specify the first resource 304(1) of the server 106 and/or other information. Responsive to receiving the first request, the device 302 may extract/obtain/acquire the first resource 304(1) from the first request. After extracting the first resource 304(1) from the first request, the device 302 may add the first resource 304(1) to the accessed-resource list 308. The accessed-resource list 308 (e.g., an accessed-URL list and/or other lists) may indicate/specify one or more resources 304 accessed by the client 102 during a session between the client 102 and the server 106. The device 302 may store/maintain the accessed-resource list 308 with the information of the session. In some embodiments, the device 302 may obtain/access/use the accessed-resource list 308 from the session data by using the session identifier as a key or identifier (e.g., to index in a database of accessed-resource lists).

Referring now to operation (506), and in some embodiments, the device 302 may receive/obtain a response from the server 106. In some embodiments, the device 302 may send/transmit/broadcast/forward the first request from the client 102 to the server 106. Responsive to receiving the first request, the server 106 may send/transmit the response (e.g., HTTP RESPONSE) to the device 302. The response from the server 106 may include/provide/specify a second resource 304(2) (e.g., a second URL), one or more resources 304 and/or other information. In some embodiments, the device 302 may establish/generate/configure a session identifier for the session between the client 102 and the server 106. The response from the server 106 may include a set-cookie command, the session identifier, and/or other information. Responsive to receiving the response from the server 106, the device 302 may communicate/send/transmit/provide the response including a set-cookie command with the session identifier to the client 102.

Referring now to operation (508), and in some embodiments, the device 302 may incorporate/integrate/add a mapping 312 to a shared data structure 310 (e.g., a global parent list). The mapping 312 may include or correspond to a mapping/association/relationship between an indication of the second resource 304(2) and the first resource 304(1). The indication of the second resource 304(2) may include or correspond to a unique ID of the second resource 304(2), the second resource 304(2) itself, and/or other types of indications. For example, the mapping 312 may correspond to a mapping between one or more unique IDs and the first resource 304(1), wherein the one or more unique IDs can specify/indicate one or more second resources 304(2). In some embodiments, the mapping 312 may indicate/specify/provide a parent-child relationship between two or more resources 304. For example, the mapping 312 may specify that the first resource 304(1) is a parent resource of one or more resources 304 (for example, a second resource 304(2)). In some embodiments, the shared data structure 310 may include/specify/provide/indicate one-to-many (e.g., one-to-N) mappings between resources 304 associated with a plurality of sessions. For example, a second resource 304(2) (e.g., a URL and/or other resources) may be related/associated/mapped/linked to one or more parent resources (e.g., parent URLs and/or parent resources).

Referring now to operation (510), and in some embodiments, the device 302 may receive/obtain a second request. The device 302 within the session may receive the second request (e.g., HTTP GET and/or other requests) from the client 102, an attacker (e.g., malicious entity), and/or another entity. The second request may include or correspond to a request to access/use/retrieve one or more resources 304 of the server 106. The second request may include/provide/indicate a third resource 304(3) of the server 106. For example, the second request may include or correspond to a request to access/use a third resource 304(3) of the server 106. In some embodiments, the device 302 may add/append/incorporate/integrate the third resource 304(3) to the accessed-resource list 308 of the session between the client 102 and the server 106. Responsive to determining to allow the server 106 to receive the second request, the device 302 may receive/obtain a response from the server 106 to the second request. The response from the server 106 to the second request may include/provide/specify a fourth resource 304(4) and/or one or more resources 304. The device 302 may incorporate/aggregate/add a mapping 312 to the shared data structure 310. The mapping 312 may include or correspond to a mapping/association/relationship between an indication of the fourth resource 304(4) (e.g., a unique ID of the fourth resource 304(4) and/or the fourth resource 304(4) itself) and the third resource 304(3).

In some embodiments, the second request may include/provide/specify a cookie with the session identifier and/or other information. Responsive to receiving the second request, the device 302 may extract/obtain/acquire/determine the session identifier and/or the cookie from the second request. The device 302 may use the session identifier, the cookie, and/or other information to access/retrieve/use the accessed-resource list 308 of the session. For example, the device 302 may use the session identifier as a key to access/retrieve/use the accessed-resource list 308. The device 302 may validate/verify/confirm the session identifier determined from the second request. Responsive to receiving the second request, the device 302 may determine whether to allow the server 106 to receive/obtain the second request.

Referring now to operation (512), and in some embodiments, the device 302 may prevent/preclude a server 106 from receiving the second request. Responsive to receiving the second request, the device 302 may retrieve/fetch/obtain/acquire the shared data structure 310 and/or the accessed-resource list 308. The device 302 may determine whether the shared data structure 310 and/or the accessed-resource list 308 include at least one resource (e.g., a start URL). For example, the device 302 may determine whether the shared data structure 310 includes at least one resource that is mapped to an indication of the third resource 304(3). In another example, the device 302 may determine whether at least one resource in the shared data structure 310 that is mapped to an indication of the third resource 304(3) is absent from the accessed-resource list 308. If the at least one resource is absent from the shared data structure 310 and/or the accessed-resource list 308, the device 302 may determine to prevent/preclude the server 106 from receiving the second request (e.g., a request to access a third resource 304(3)). For example, if the device 302 determines to prevent the server 106 from receiving the second request, the device 302 may send/transmit/broadcast a response to the client 102 (or attacker) indicating the third resource 304(3) is absent/unknown/invalid. In some embodiments, the device 302 may determine that the second request is malicious and/or potentially malicious when the at least one resource is absent from the shared data structure 310 and/or the accessed-resource list. For example, if a start URL (or other resources) is absent from the shared data structure 310 and/or accessed-resource list 308 (or otherwise unknown/invalid), the device 302 may determine that the second request is potentially malicious.

Referring now to operation (514), and in some embodiments, the device 302 may allow/permit the server 106 to receive the second request. In some embodiments, the device 302 may extract/obtain an indication of the third resource 304(3) from the second request. The device 302 may determine that the indication of the third resource 304(3) is mapped to at least one resource in the shared data structure 310. The device 302 may determine that the at least one resource in the shared data structure 310 is present/included in the accessed-resource list 308. If the indication of the third resource 304(3) is mapped to at least one resource in the shared data structure 310 that is present/included in the accessed-resource list, the device 302 may determine to allow the server 106 to receive/obtain the second request. For example, the device 302 may determine that the shared data structure 310 and the accessed-resource list 308 include at least one resource that is mapped to the indication of the third resource 304(3). In response, the device 302 may send/transmit/broadcast/communicate the second request (e.g., a request to access/use the third resource 304(3)) to the server 106. In some embodiments, the device 302 may analyze/examine/use the mapping 312 of the shared data structure 310 to determine whether the at least one resource 304 is mapped to the indication of the third resource 304(3). Responsive to receiving the second request, the server 106 may send/transmit a response to the client 102 via the device 302. The response from the server 106 may include/specify/provide one or more resources 304 and/or other information.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method comprising:
receiving, by device intermediary between a client and a server, a first request from the client that includes a first resource of the server;
adding, by the device, the first resource to an accessed-resource list of a session between the client and the server;
receiving, by the device, a response from the server to the first request, that includes a second resource;
incorporating, by the device, a mapping between an indication of the second resource and the first resource, to a shared data structure;
receiving, by the device within the session, a second request that includes a third resource of the server; and
determining, by the device, to allow the server to receive the second request when an indication of the third resource is mapped to at least one resource in the shared data structure that is present in the accessed-resource list.

2. The method of claim 1, comprising:
determining, by the device, to prevent the server from receiving the second request when the at least one resource is absent in at least one of: the shared data structure or the accessed-resource list.

3. The method of claim 1, comprising:
determining, by the device, that the second request is malicious or potentially malicious when the at least one resource is absent in at least one of: the shared data structure or the accessed-resource list.

4. The method of claim 1, comprising:
establishing, by the device, a session identifier for the session; and
communicating, by the device to the client, the response including a set-cookie command with the session identifier.

5. The method of claim 4, comprising:
receiving, by the device, the second request, the second request including a cookie with the session identifier; and
accessing, by the device, the accessed-resource list of the session according to the session identifier.

6. The method of claim 5, comprising:
determining, by the device, the session identifier from the second request; and
validating, by the device, the session identifier determined from the second request.

7. The method of claim 1, wherein the shared data structure includes one-to-many mappings between resources associated with a plurality of sessions.

8. The method of claim 1, comprising:
parsing, by the device, the first resource from the first request; and
communicating, by the device, the first request to the server after parsing the first resource from the first request.

9. The method of claim 1, comprising:
adding, by the device, the third resource to the accessed-resource list of the session between the client and the server;
receiving, by the device, a response from the server to the second request, that includes a fourth resource; and
incorporating, by the device, a mapping between an indication of the fourth resource and the third resource, to the shared data structure.

10. A device, comprising:
at least one processor configured to:
receive a first request from a client that includes a first resource of a server;
add the first resource to an accessed-resource list of a session between the client and the server;
receive a response from the server to the first request, that includes a second resource;
incorporate a mapping between an indication of the second resource and the first resource, to a shared data structure;
receive a second request that includes a third resource of the server within the session; and
determine to allow the server to receive the second request when an indication of the third resource is mapped to at least one resource in the shared data structure that is present in the accessed-resource list.

11. The device of claim 10, wherein the at least one processor is configured to:
determine to prevent the server from receiving the second request when the at least one resource is absent in at least one of: the shared data structure or the accessed-resource list.

12. The device of claim 10, wherein the at least one processor is configured to:
determine that the second request is malicious or potentially malicious when the at least one resource is absent in at least one of: the shared data structure or the accessed-resource list.

13. The device of claim 10, wherein the at least one processor is configured to:
establish a session identifier for the session; and
communicate the response including a set-cookie command with the session identifier to the client.

14. The device of claim 13, wherein the at least one processor is configured to:
receive the second request, the second request including a cookie with the session identifier; and
access the accessed-resource list of the session according to the session identifier.

15. The device of claim 14, wherein the at least one processor is configured to:
determine the session identifier from the second request; and
validate the session identifier determined from the second request.

16. The device of claim 10, wherein the shared data structure includes one-to-many mappings between resources associated with a plurality of sessions.

17. The device of claim 10, wherein the at least one processor is configured to:
parse the first resource from the first request; and
communicate the first request to the server after parsing the first resource from the first request.

18. The device of claim 10, wherein the at least one processor is configured to:
add the third resource to the accessed-resource list of the session between the client and the server;
receive a response from the server to the second request, that includes a fourth resource; and
incorporate a mapping between an indication of the fourth resource and the third resource, to the shared data structure.

19. A non-transitory computer readable medium storing program instructions for causing at least one processor of a device to:
receive a first request from a client that includes a first resource of a server;
add the first resource to an accessed-resource list of a session between the client and the server;
receive a response from the server to the first request, that includes a second resource;
incorporate a mapping between an indication of the second resource and the first resource, to a shared data structure;
receive a second request that includes a third resource of the server within the session; and
determine to allow the server to receive the second request when an indication of the third resource is mapped to at least one resource in the shared data structure that is present in the accessed-resource list.

20. The non-transitory computer readable medium of claim 19, wherein the program instructions cause the at least one processor to:
establish a session identifier for the session; and
communicate the response including a set-cookie command with the session identifier to the client.
